(19) United States
(12) Patent Application Publication
(10) Pub. No.: US 2016/0038899 A1
(43) Pub. Date: Feb. 11, 2016

(54) EXTENDED CONTACT TIME RISER

(71) Applicant: UOP LLC, Des Plaines, IL (US)

(72) Inventors: Patrick D. Walker, Park Ridge, IL (US); Matthew Lippmann, Chicago, IL (US); Mark Schnaith, Lake Zurich, IL (US)

(21) Appl. No.: 14/919,846

(22) Filed: Oct. 22, 2015

Related U.S. Application Data
(62) Division of application No. 13/907,232, filed on May 31, 2013.

(51) Int. Cl. B01J 8/24; C10G 11/18; B01J 8/18

(52) U.S. Cl. CPC B01J 8/24; B01J 8/1872; C10G 11/18; B01J 2208/00893

(57) ABSTRACT

A riser includes a housing in communication with a entry conduit and an exit conduit. The housing is defined by a holdup chamber having a volume of between about 1133 liters and about 45307 liters. The riser is designed to receive a hydrocarbon feed and a catalyst. An apparatus for fluid catalytic cracking includes a riser in fluid communication with a reactor vessel. A hydrocarbon feed stream and a catalyst travel through a first section of the riser at a first velocity of between about 1.5 msec to about 10 msec and through a second section of the riser at a second velocity of more than about 15 msec. A process for fluid catalytic cracking uses a riser with a holdup chamber. A hydrocarbon feed and a catalyst decrease in velocity in the holdup chamber to between 1.5 msec and 10 msec.

### CROSS-REFERENCE TO RELATED APPLICATION

This application is a Division of copending application Ser. No. 13/907,232 filed May 31, 2013, the contents of which are hereby incorporated by reference in its entirety.

### FIELD OF THE INVENTION

This invention relates to a riser for use in a fluid catalytic cracking system, and more particularly to a riser having a design that increases the conversion rate of feedstock flowing therethrough.

### BACKGROUND OF THE INVENTION

Fluid catalytic cracking (FCC) is a catalytic hydrocarbon conversion process accomplished by contacting heavier hydrocarbons in a fluidized reaction zone with a catalytic particulate material. The reaction in catalytic cracking, as opposed to hydrocracking, is carried out in the absence of substantial added hydrogen or the consumption of hydrogen. As the cracking reaction proceeds, substantial amounts of highly carbonaceous material referred to as coke are deposited on the catalyst to provide coked or spent catalyst. Vaporous lighter products are separated from spent catalyst in a reactor vessel. Spent catalyst may be subjected to stripping over an inert gas such as steam to strip entrained hydrocarbonaceous gases from the spent catalyst. A high temperature regeneration with oxygen within a regeneration zone operation burns coke from the spent catalyst that may have been stripped. Various products may be produced from such a process, including a naphtha product and/or a light product such as propylene and/or ethylene.

The basic components of the FCC process include an internal or external riser, a reactor vessel in which spent catalyst is disengaged from product vapors, a regenerator, and a catalyst stripper. In the riser, the hydrocarbon feed contacts the catalyst and is cracked into a product stream containing lighter hydrocarbons. A gas stream is typically used to accelerate catalyst in a first section of the riser before introduction of the feed. Regenerated catalyst and the hydrocarbon feed are transported upwardly in the riser by the expansion of the gases that result from the vaporization of the hydrocarbons, and other fluidizing mediums, upon contact with the hot catalyst.

In such processes, a single reactor vessel or a dual reactor vessel can be utilized. Although additional capital costs may be incurred by using a dual reactor vessel, one of the reactors can be operated to tailor conditions for maximizing products, such as light olefins including propylene and/or ethylene. It can often be advantageous to maximize yield of a product in one of the reactors. Additionally, there may be a desire to maximize the production of a product from one reactor that can be recycled back to the other reactor to produce a desired product, such as propylene. Normally if two reactors are used, a single product recovery system is utilized for product separation. Separate product recovery systems have also been proposed. Maximizing synergies between two reactor systems is greatly desired.

The conversion efficiency of feedstock as it travels through a riser is dependent upon various factor including, for example, riser temperature, pressure, catalyst/oil ratio, catalyst properties, zeolite concentration in the circulating catalyst, and various other factors including the residence time in the reactor. One particularly difficult obstacle is the conversion of the feedstock into propylene, which is limited by equilibrium.

Commercially there is a demand for FCC technology capable of producing high propylene yields from conventional feedstocks. While it is possible to affect the propylene yield in a conventional FCC unit by adjusting the process conditions and the catalyst composition, the extent of propylene production is equilibrium-limited. One means of increasing the propylene yield is to decrease the reactor pressure to decrease olefin partial pressure. However, reducing the reactor pressure leads to a large increase in capital cost and an even larger increase in the utility costs. An alternative solution is feeding light naphtha to the primary reactor riser or to a second reactor riser from a conventional separation section having a main column and gas recovery unit. Both of these options result in an increase in capital costs, but the process economics are much more favorable than simply reducing the reactor pressure. If one recycles light naphtha to a conventional reactor riser to increase propylene yield, the capital costs increase slightly with essentially no increase in utility costs. Propylene yield can be increased to still a greater extent more economically by increasing the residence time of the feedstock in the riser. One such way that the residence time may be increased is through the use of a specially designed riser according to the disclosure herein.

### SUMMARY OF THE INVENTION

According to one aspect of the invention, a riser comprises a housing in communication with a entry conduit and an exit conduit. The housing is defined by a holdup chamber having a volume of between about 1133 liters (40 ft³) to about 45307 liters (1600 ft³), and is designed to receive a hydrocarbon feed and a catalyst. The width dimension of the holdup chamber can be greater than the width dimension of at least one of the entry conduit or exit conduits. The width dimension of the holdup chamber can be greater than the width dimension of both of the entry conduit and exit conduits. The holdup chamber can include an angled lower surface and an angled upper surface, wherein the angled lower surface and the angled upper surface are each characterized by an angle of between about 20 degrees to about 60 degrees. The holdup chamber can disrupt the flow of the catalyst along an interior surface thereof.

According to another aspect of the invention, an apparatus for fluid catalytic cracking includes a riser in communication with a reactor vessel designed to receive a feed stream and a catalyst. The feed stream and the catalyst travel through a first section of the riser at a first velocity of between about 1.524 msec (5 ft/sec) to about 9.144 msec (30 ft/sec) and through a second section of the riser at a second velocity of more than about 15.24 msec (50 ft/sec). The feedstream can comprise C₄ to C₇ olefins. The catalyst can be a zeolite. The feed stream may react with the catalyst to form polypropylene. The feed stream can comprise a previously cracked feed. The riser can be defined by a holdup chamber. The holdup chamber can include a protruding section that increases the residence time of the feed stream and the catalyst therein. The holdup chamber can include at least one angled surface disposed adjacent an upper or lower surface. Both an upper and a lower surface of the holdup chamber can be angled. The volume dimension of the holdup chamber can be about 1133 liters (40 ft³) to about 45307 liters (1600 ft³). The first section of the riser can be the holdup chamber.

According to yet another aspect of the invention, a process for fluid catalytic cracking uses a riser including a housing in fluid communication with an entry conduit and an exit conduit, wherein the housing is defined by a holdup chamber. A hydrocarbon feed and a catalyst are directed through the entry conduit, the housing, and the exit conduit of the riser. A velocity of the hydrocarbon feed and the catalyst decreases in the holdup chamber such that the velocity of the hydrocarbon feed and the catalyst is between about 1.5 msec and about 10 msec as the feed and catalyst are traveling through the holdup chamber. The velocity of the hydrocarbon feed and the catalyst may be less than about 4.5 m/sec as the feed and catalyst enter the entry conduit. A residence time of the hydrocarbon feed and the catalyst in the holdup chamber can be between about 0.5 to about 5.0 seconds.

These and other features, aspects, and advantages of the present invention will become better understood upon consideration of the following detailed description, drawings, and appended claims.

### BRIEF DESCRIPTION OF THE DRAWINGS

FIG. 1 is a schematic view of one embodiment of a fluid catalytic cracking process that utilizes a riser.

FIG. 2 is an isometric view of one embodiment of a riser for use in the process of FIG. 1.

FIG. 3 is an isometric view of another embodiment of a riser for use in the process of FIG. 1.

FIG. 4 is a side elevational view of the riser of FIG. 4.

FIG. 5 is a partial cross-sectional view of the riser of FIG. 4 taken generally along the lines 5-5 of FIG. 3.

### DETAILED DESCRIPTION OF THE DRAWINGS

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

This invention relates generally to a riser for use in an FCC process, and to the improved FCC process. The process and apparatus of this invention can be used to modify the operation and arrangement of existing FCC units or in the design of newly constructed FCC units.

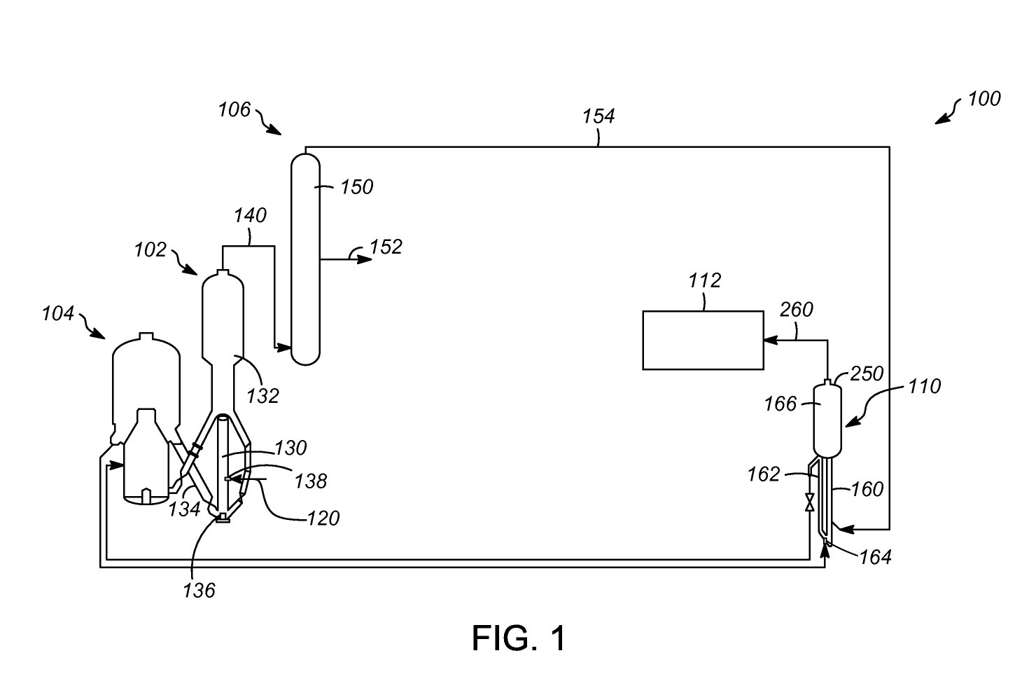

The present invention is an apparatus and process that may be described with reference to numerous components generally depicted in FIG. 1. In particular, an FCC process 100 includes a first catalytic reactor 102 that is operatively connected to a regenerator vessel 104 and a first product fractionation section 106. The first product fractionation section 106 is in communication with a second catalytic reactor 110 and a second product recovery section 112. A gas recovery section (not shown) is optionally provided that is in communication with the first product fractionation section 106. Many configurations of the present invention are possible, but specific embodiments are presented herein by way of example. All other possible embodiments for carrying out the present invention are considered within the scope of the present invention. For example, if the first and second reactors 102, 110 are not FCC reactors, the regenerator vessel 104 may be optional. One particularly useful FCC process 100 and associated components that utilize a riser discussed herein is described in U.S. Patent Application Publication No. 2011/0110825 which is incorporated herein by reference in its entirety.

A conventional FCC feedstock and higher boiling hydrocarbon feedstock are a suitable first feed 120 to the first reactor 102. The most common of such conventional feedstocks is a “vacuum gas oil” (VGO), which is typically a hydrocarbon material having a boiling range of from about 343° C. to about 552° C. (650° F. to 1025° F.) prepared by vacuum fractionation of atmospheric residue. Such a fraction is generally low in coke precursors and heavy metal contamination that can serve to contaminate catalyst. Heavy hydrocarbon feedstocks to which this invention may be applied include heavy bottoms from crude oil, heavy bitumen crude oil, shale oil, tar sand extract, deasphalted residue, products from coal liquefaction, atmospheric and vacuum reduced crudes. Heavy feedstocks for this invention also include mixtures of the above hydrocarbons and the foregoing list is not comprehensive. Moreover, additional amounts of feed may also be introduced downstream of the initial feed point.

The first reactor 102 may be a catalytic or an FCC reactor that includes a first reactor riser 130 in communication with a first reactor vessel 132. A regenerator catalyst standpipe 134 is in upstream communication with the first reactor 102. The regenerator catalyst standpipe 134 delivers regenerated catalyst from the regenerator vessel 104 at a rate regulated by a control valve to the first reactor 102 through a regenerated catalyst inlet. A fluidization medium such as steam from a distributor 136 urges a stream of regenerated catalyst upwardly through the first reactor 102. At least one feed distributor 138 in upstream communication with the first reactor 100 injects the first feed 120, preferably with an inert atomizing gas such as steam, across the flowing stream of catalyst particles to distribute hydrocarbon feed to the first reactor 102. Upon contacting the first feed 120 with catalyst in the first reactor 102, the heavier first feed 120 cracks to produce lighter gaseous first cracked products while conversion coke and contaminant coke precursors are deposited on the catalyst particles to produce spent catalyst.

The catalyst may be a single catalyst or a mixture of different catalysts. Usually, the catalyst includes two components or catalysts, namely a first component or catalyst, and a second component or catalyst. A useful catalyst mixture is disclosed in, for example, U.S. Pat. No. 7,312,370, incorporated by reference herein in its entirety. Generally, the first component may include any of the well-known catalysts that are used in the art of FCC, such as an active amorphous clay-type catalyst and/or a high activity, crystalline molecular sieve. Zeolites may be used as molecular sieves in FCC processes. Preferably, the first component includes a large pore zeolite, such as a Y-type zeolite, an active alumina material, a binder material, including either silica or alumina, and an inert filler such as kaolin.

Typically, the zeolitic molecular sieves appropriate for the first component have a large average pore size. Usually, molecular sieves with a large pore size have pores with openings of greater than about 0.7 nanometers in effective diameter defined by greater than about 10, and typically about 12, member rings. Suitable large pore zeolite components may include synthetic zeolites such as X and Y zeolites, mordenite and faujasite. A portion of the first component, such as the zeolite, can have any suitable amount of a rare earth metal or rare earth metal oxide.

The second component may include a medium or smaller pore zeolite catalyst, such as a MFI zeolite, as exemplified by at least one of ZSM-5, ZSM-11, ZSM-12, ZSM-23, ZSM-35, ZSM-38, ZSM-48, and other similar materials. Other suitable medium or smaller pore zeolites include ferrierite, and erionite. Preferably, the second component has the medium or smaller pore zeolite dispersed on a matrix including a binder material such as silica or alumina and an inert filler material such as kaolin. The second component may also include some other active material such as Beta zeolite. These compositions may have a crystalline zeolite content of about 10 to about 50 wt % or more, and a matrix material content of about 50 to about 90 wt %. Components containing about 40 wt % crystalline zeolite material are preferred, and those with greater crystalline zeolite content may be used. Generally, medium and smaller pore zeolites are characterized by having an effective pore opening diameter of less than or equal to about 0.7 nm and rings of about 10 or fewer members. Preferably, the second catalyst component is an MFI zeolite having a silicon-to-aluminum ratio greater than about 15, preferably greater than about 75. In one exemplary embodiment, the silicon-to-aluminum ratio can be about 15:1 to about 35:1.

The total catalyst mixture may contain about 1 to about 25 wt % of the second component, including a medium to small pore crystalline zeolite with greater than or equal to about 7 wt % of the second component being preferred. When the second component contains about 40 wt % crystalline zeolite with the balance being a binder material, an inert filler, such as kaolin, and optionally an active alumina component, the catalyst mixture may contain about 0.4 to about 10 wt % of the medium to small pore crystalline zeolite with a preferred content of at least about 2.8 wt %. The first component may comprise the balance of the catalyst composition.

The high concentration of the medium or smaller pore zeolite as the second component of the catalyst mixture can improve selectivity to light olefins. In one exemplary embodiment, the second component can be a ZSM-5 zeolite and the catalyst mixture can include about 0.4 to about 10 wt % ZSM-5 zeolite excluding any other components, such as binder and/or filler.

The resulting mixture of gaseous product hydrocarbons and spent catalyst continues upwardly through the first reactor 102 and are received in the first reactor vessel 132 in which the spent catalyst and gaseous product are separated. The mixture of gas and catalyst are discharged from a top of the first reactor 102 through one or more outlet ports (not shown) into a disengaging vessel (not shown in detail) that effects partial separation of gases from the catalyst. The hydrocarbon vapors, including stripped hydrocarbons, stripping media and entrained catalyst are sent to the first reactor vessel 132 to separate spent catalyst from the hydrocarbon gaseous product stream.

The separated hydrocarbon gaseous streams from the first reactor vessel 132 are sent via a product line 140 via into the first product fractionation section 106 for product recovery.

Meanwhile, catalyst is discharged into a lower bed in the first reactor vessel 132. The catalyst with adsorbed or entrained hydrocarbons may eventually pass from the lower bed into an optional stripping section. The stripped spent catalyst leaves the first reactor vessel 132 with a lower concentration of entrained or adsorbed hydrocarbons than it had when it entered or if it had not been subjected to stripping. A first portion of the spent catalyst, preferably stripped, leaves the first reactor vessel 132 and passes into the regenerator vessel 104 at a rate regulated by a slide valve. The regenerator 104 is in downstream communication with the first reactor 102. A second portion of the spent catalyst is recirculated to the first reactor 102 at a rate regulated by a slide valve to recontact the feed without undergoing regeneration.

The regenerator vessel 104 is in downstream communication with the first reactor vessel 132. In the regenerator vessel 104, coke is combusted from the portion of spent catalyst delivered to the regenerator vessel 104 by contact with an oxygen-containing gas such as air to provide regenerated catalyst. The regenerator vessel 104 may be a combustor type of regenerator as shown in FIG. 1, but other regenerator vessels and other flow conditions may be suitable for the present invention. The oxygen in the combustion gas contacts the spent catalyst and combusts carbonaceous deposits from the catalyst to at least partially regenerate the catalyst and generate flue gas.

As discussed previously herein, the first cracked products in the line 140 from the first reactor 102 are relatively free of catalyst particles and includes the stripping fluid. The cracked products exit the first reactor vessel 132 and may optionally be subjected to additional treatment to remove fine catalyst particles or to further prepare the stream prior to fractionation. The line 140 transfers the first cracked products stream to the product fractionation section 106, which in one embodiment, may include a main fractionation column 150 and a gas recovery section (not shown).

The main fractionation column 150 is a fractionation column with trays and/or packing positioned along its height for vapor and liquid to contact and reach equilibrium proportions at tray conditions and a series of pump-arounds to cool the contents of the main column. The main fractionation column 150 is in downstream communication with the first reactor 102 and can be operated with a top pressure of about 35 to about 350 kPa (gauge) (5 to 50 psig) and a bottom temperature of about 343° C. to about 399° C. (650° F. to 750° F.).

A variety of products are withdrawn from the main fractionation column 150. For example, one or more product streams 152 are recovered from the fractionation column 150 and may be further processed. Another (second) feed 154, typically a C₄-C₁₂ stream, is recovered from the fractionation column 150 and further processed. The feed 154 may be subjected to vaporization in an evaporator (not shown) and/or mixed with other streams to form a second hydrocarbon feed. The second feed 154 is delivered to the second catalytic reactor 110 that is in downstream communication with an overhead of the main fractionation column 150.

The second catalytic reactor 110 may be a second FCC reactor. The second feed 154 may be at least partially comprised of C₁₀-hydrocarbons, preferably comprising C₄ to C₇ olefins. The second feed 154 predominantly comprises hydrocarbons with 12 or fewer carbon atoms and preferably between 4 and 12 carbon atoms. The second feed 154 preferably comprises a portion of the first cracked products produced in the first reactor 102, fractionated in the main column 150 and provided to the second reactor 110.

The second reactor 110 includes a second riser 160. The second feed 154 is contacted with catalyst delivered to the second reactor 110 by a catalyst return standpipe 162 in upstream communication with the second riser 160 to produce cracked upgraded products. The catalyst may be fluidized by inert gas such as steam from a distributor 164. Generally, the second reactor 110 may operate under conditions to convert the light naphtha feed to smaller hydrocarbon products. C₄-C₇ olefins crack into one or more light olefins, such as ethylene and/or propylene. A second reactor vessel 166 is in downstream communication with the second riser 160 for receiving upgraded products and catalyst therefrom. The mixture of gaseous, upgraded product hydrocarbons and catalyst continues upwardly through the second riser 160 and is received in the second reactor vessel 166 in which the catalyst and gaseous hydrocarbon, upgraded products are separated.

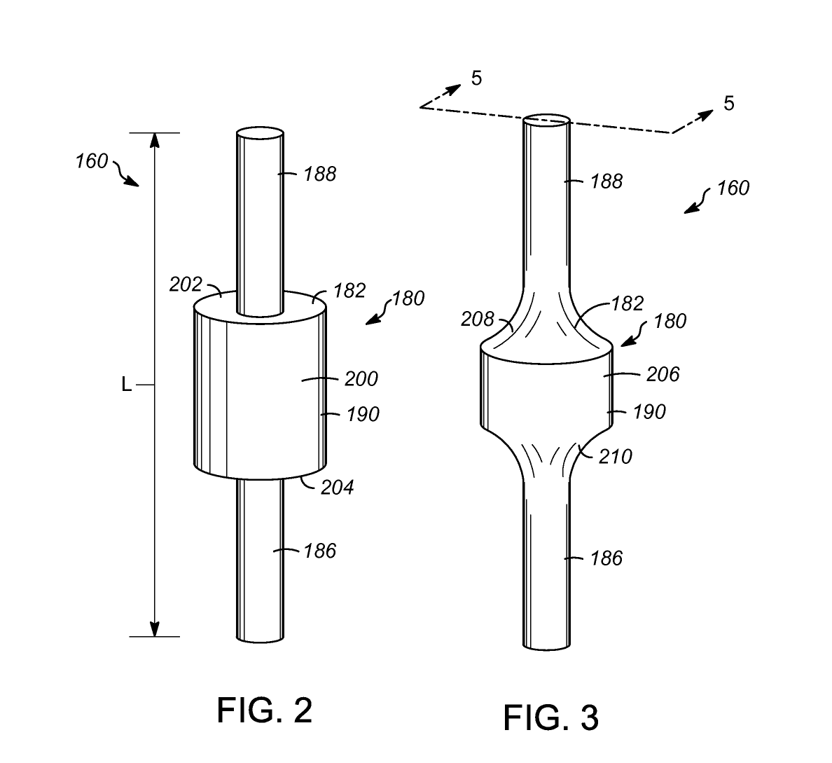

The second riser 160 for use in the FCC process 100 herein preferably includes a specialized design that increases the yield of light olefins (e.g., polypropylene) from the second hydrocarbon feed 154. Referring more particularly to FIGS. 2-5, the second riser 160 is defined by a housing 180 having an exterior surface 182 and an interior surface 184. The second riser 160 includes a lower entry conduit 186 and an upper exit conduit 188 with a holdup chamber 190 disposed therebetween.

The lower entry conduit 186 is designed to supply the second feed 154 and/or the catalyst through the holdup chamber 190, out of the exit conduit 188, and into the second reactor vessel 166. As the second feed 154 travels through the second riser 160, catalyst contacts the second feed 154 to produce one or more light olefins, such as ethylene and/or propylene. In particular, the holdup chamber 190 is designed to accommodate the hydrocarbon feed (not shown) as it contacts a catalyst (not shown) and is cracked into a product stream (not shown) containing lighter hydrocarbons. The catalyst and the hydrocarbon feed are transported upwardly in the second riser 160 by the expansion of the gases that result from the vaporization of the hydrocarbons, and other fluidizing mediums, upon contact with the hot catalyst.

The holdup chamber 190 is characterized by a specially designed shape that increases the catalyst/feed 154 residence time within the second riser 160. The holdup chamber 190 may be designed in a variety of ways so long as at least one portion of the chamber 190 protrudes outwardly from one or more of the lower entry conduit 186 and/or the upper exit conduit 186. In one embodiment shown in FIG. 2, the holdup chamber 190 is defined by a substantially cylindrical body 200 having a flat upper surface 202 and a flat lower surface 204. In a further embodiment depicted in FIG. 3, the holdup chamber 190 is defined by a smaller cylindrical section 206 that is truncated by opposing first and second curved ends 208, 210.

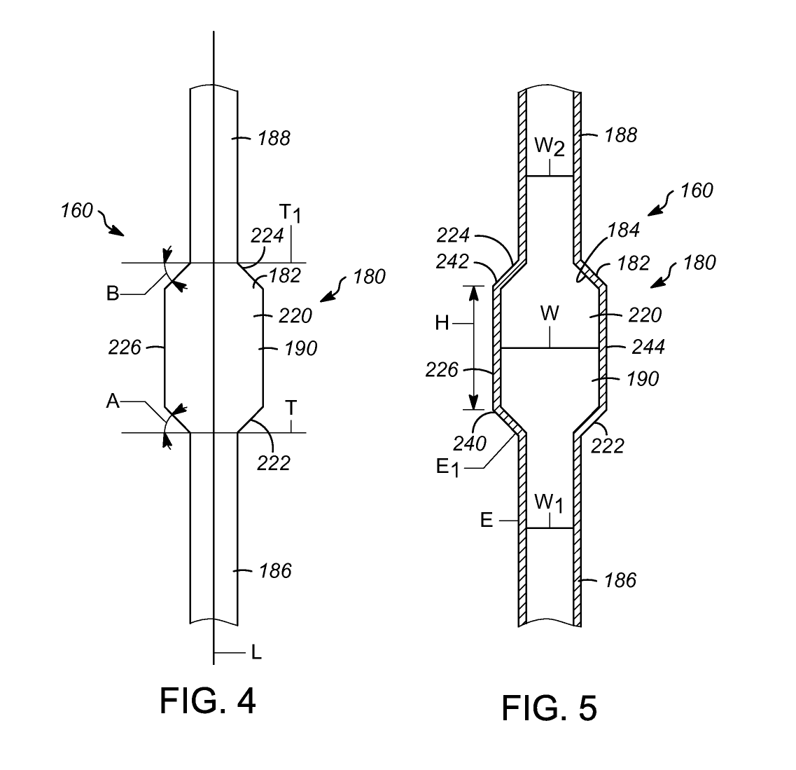

In a different embodiment, as best seen in FIGS. 4 and 5, the holdup chamber 190 includes a protruding section 220 having an angled lower surface 222 and an angled upper surface 224 with a straightened section 226 therebetween. The lower surface 222 is defined by an angle A of between about 10 degrees to about 85 degrees as determined from a transverse axis T perpendicular to a longitudinal axis L of the second riser 160. In one embodiment, the angle A is between about 20 degrees to about 75 degrees. In a different embodiment, the angle A is between about 30 degrees to about 60 degrees. In a further embodiment, the angle A is between about 40 degrees to about 50 degrees. In one particular embodiment, the angle A is 40 degrees. In a different embodiment, the angle A is 45 degrees. In a further embodiment, the angle A is 50 degrees.

Similarly, the angled upper surface 224 is defined by an angle B of between about 10 degrees to about 85 degrees as determined from a transverse axis T perpendicular to the longitudinal axis L of the second riser 160. In one embodiment, the angle B is between about 20 degrees to about 75 degrees. In a different embodiment, the angle B is between about 30 degrees to about 60 degrees. In a further embodiment, the angle B is between about 40 degrees to about 50 degrees. In one particular embodiment, the angle B is 40 degrees. In a different embodiment, the angle B is 45 degrees. In a further embodiment, the angle B is 50 degrees. In one embodiment, the angles A and B are preferably substantially the same. In another embodiment, the angles A and B are different.

The angling of both the upper surface 224 and the lower surface 222 is designed in a manner that disrupts the flow of the catalyst along the interior surface 184 of the second riser 160. Namely, as the catalyst travels upwardly through the second riser 166, the catalyst travels upwardly along the interior surface 184 adjacent the lower angled surface 222. Once entering the holdup chamber 190, the catalyst is dispersed outwardly toward the straightened section 226. The holdup chamber 190 retains the catalyst and second feed 154 for a residence time typically longer than that currently known in the art. In particular, the residence time is typically between about 1 to about 10, or more particularly between about 2 to about 5, and most preferably about 3 seconds. After leaving the holdup chamber 190, the propylene and other product exit the second riser 160 through the exit conduit 188 into the second reactor vessel 166.

The straightened section 226 of the second riser 160 preferably includes a height dimension H (see FIG. 5) of between about 1.52 meters (5 ft.) to about 9.14 meters (30 ft.) as measured from a first point 240 adjacent the intersection of the lower surface 222 and the straightened section 226 to a second point 242 adjacent the intersection of the upper surface 224 and the straightened section 226. The height H is between about 1.52 meters (5 ft.) to about 9.14 meters (30 ft.). In a different embodiment, the height H is between about 3.05 meters (10 ft.) to about 6.1 meters (20 ft.). In a further embodiment, the height H is between about 3.81 meters (12.5 ft.) to about 5.33 meters (17.5 ft.). In one particular embodiment, the height H is between about 4.57 meters (15 ft.) to about meters 4.88 (16 ft.).

The second riser 160 includes a total length dimension L that is between about 3.05 meters (10 ft.) to about 60.96 meters (200 ft.). In a different embodiment, the length dimension L is between about 15.24 meters (50 ft.) to about 30.48 meters (100 ft.). In a further embodiment, the length dimension is between about 22.86 meters (75 ft.) to about 30.48 meters (100 ft.).

The holdup chamber 190 includes a width dimension W at an approximate centerpoint 244 that is between about 0.61 meters (24 inches) to about 3.66 meters (144 inches). In another embodiment, the width W is between about 0.91 meters (36 inches) to about 3.05 meters (120 inches). In a different embodiment, the width W is between about 1.22 meters (48 inches) to about 2.44 meters (96 inches). In a further embodiment, the width W is between about 1.52 meters (60 inches) to about 1.83 meters (72 inches). In one particular embodiment, the width W is between about 1.65 meters (65 inches) to about 1.78 meters (70 inches). The holdup chamber 190 further includes a volume dimension V of between about 1133 liters (40 ft³) to about 45,307 liters (1600 ft³). In another embodiment, the volume dimension V is between about 2832 liters (100 ft³) to about 33,980 liters (1200 ft³). In a different embodiment, the volume dimension V is between about 7079 liters (250 ft³) to about 21,238 liters (750 ft³). In one particular embodiment, the volume dimension V is between about 11,327 liters (400 ft³) to about 12,743 liters (450 ft³).

Similarly, the lower entry conduit 186 and the exit conduit 188 each have width dimensions W₁ and W₂, respectively, that are smaller than that of the holdup chamber 190. The width W₁ is between about 0.305 meters (12 inches) to about 1.83 meters (72 inches). In a different embodiment, the width W₁ is between about 0.61 meters (24 inches) to about 1.52 meters (60 inches). In a further embodiment, the width W₁ is between about 0.91 meters (36 inches) to about 1.22 meters (48 inches). In one particular embodiment, the width W₁ is between about 1.02 meters (40 inches) to about 1.14 meters (45 inches). The width W₂ is between about 0.305 meters (12 inches) to about 1.83 meters (72 inches). In a different embodiment, the width W₂ is between about 0.61 meters (24 inches) to about 1.52 meters (60 inches). In a further embodiment, the width W₂ is between about 0.91 meters (36 inches) to about 1.22 meters (48 inches). In one particular embodiment, the width W₂ is between about 1.02 meters (40 inches) to about 1.14 meters (45 inches). In one embodiment, the width W₁ of the lower entry conduit 186 is different from the width W₂ of the exit conduit 188. In a different embodiment, the width W₁ of the lower entry conduit 186 is substantially similar to the width W₂ of the exit conduit 188.

The ratio of the width dimension W of the holdup chamber 190 to the width dimensions W₁ and W₂ (riser inside diameters) of the lower entry conduit 186 and the exit conduit 188 are between about 1.1 to about 4.0. In another embodiment, the ratio is between about 1.5 to about 3.0. In a further embodiment, the ratio is between about 1.8 to about 2.2.

The ratio of the height dimension H to the width dimension W (riser inside diameter) of the holdup chamber 190 is between about 0.4 to about 15. In another embodiment, the ratio is between about 3 to about 12. In a further embodiment, the ratio is between about 5 to about 9.

The ratio of the height dimension H to the width dimensions W₁ and W₂ (riser inside diameters) of the lower entry conduit 186 and the exit conduit 188 are between about 0.8 to about 30. In another embodiment, the ratio is between about 5 to about 25. In a further embodiment, the ratio is between about 10 to about 20.

The ratio of the total length dimension L to the width dimension W (riser inside diameter) of the holdup chamber 190 is between about 0.8 to about 100. In another embodiment, the ratio is between about 20 to about 80. In a further embodiment, the ratio is between about 40 to about 60.

The ratio of the total length dimension L to the width dimensions W₁ and W₂ (riser inside diameters) of the lower entry conduit 186 and the exit conduit 188 are between about 1.6 to about 200. In another embodiment, the ratio is between about 40 to about 160. In a further embodiment, the ratio is between about 80 to about 120.

The speed at which the catalyst and second feed 154 travel through the second riser 160 varies therethrough. In particular, as the second feed 154 enters the lower entry conduit 186, the velocity is between about 1.5 msec to about 8 msec, more preferably between about 3 msec and about 6 msec, and most preferably about 4 to about 5 msec. As the catalyst and second feed 154 enter the holdup chamber 190, the velocity decreases. In particular, the velocity of the second feed 154 and catalyst traveling through the holdup chamber 190 is between about 0.5 msec to about 15 msec, more preferably between about 1 msec to about 9 msec, and most preferably about 4 to about 5 msec. As the feed 154 and catalyst exit the holdup chamber 190, the velocity increases. Namely, the velocity increases to between about 12 msec to about 28 msec, more preferably between about 15 msec to about 22 msec, and most preferably about 17 to about 19 msec.

The second riser 160 can operate in any suitable condition, such as a temperature between about 500° C. and about 600° C., preferably between about 520° C. and about 580° C., and more preferably between about 540° C. and about 560° C. The pressure in the second riser 160 may be any suitable pressure, such as, a pressure of about 30 to about 200 kPa(g), preferably a pressure of about 50 to about 100 kPa(g), and more preferably a pressure of about 60 to about 70 kPa(g).

The feed 154 and/or catalyst may enter the riser 160 through a variety of entry points disposed along the riser 160. The entry points are preferably openings that are in communication with one or more of the feed and or catalyst lines. For example, the feed 154 and/or catalyst may enter the riser 160 at a point along the entry conduit 186. In a different embodiment, the feed 154 and/or catalyst may enter the riser 160 through the holdup chamber 190, and more particularly, through the lower angled surface 222 of the holdup chamber 190. In one particular embodiment, the feed 154 enters the riser 160 at a point E, shown on FIG. 5. In a different embodiment, the feed 154 enters the riser 160 at a point E₁ adjacent the lower angled surface 222.

The mixture of gas and catalyst are discharged from a top of the second riser 160 through one or more outlet ports into the second reactor vessel 166 that effects partial separation of gases from the catalyst. The catalyst can drop to a dense catalyst bed within the second reactor vessel 166. Cyclones (not shown) in the second reactor vessel 166 may further separate catalyst from second cracked products. Afterwards, the second cracked hydrocarbon products can be removed from the second reactor 110 through an outlet 250 in downstream communication with the second riser 160 through a second cracked products line 260. Separated catalyst may be recycled via the recycle catalyst standpipe 162 from the second reactor vessel 166 regulated by a control valve back to the second riser 160 to be contacted with the second feed 154. After exiting the second reactor 166, the second products travel through line 260 and are directed to the second product recovery section 112.

While the foregoing written description of the invention enables one of ordinary skill to make and use what is considered presently to be the best mode thereof, those of ordinary skill will understand and appreciate the existence of variations, combinations, and equivalents of the specific exemplary embodiments thereof. The invention is therefore to be limited not by the exemplary embodiments herein, but by all embodiments within the scope and spirit of the appended claims.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing, all temperatures are set forth in degrees Celsius and, all parts and percentages are by weight, unless otherwise indicated. Additionally, control valves expressed as either open or closed can also be partially opened to allow flow to both alternative lines.

1. A riser, comprising:
a housing in communication with an entry conduit and an exit conduit,
wherein the housing is defined by a holdup chamber having a volume of between about 1133 liters to about 45307 liters, and wherein the housing is designed to receive a hydrocarbon feed and a catalyst.

2. The riser of claim 1, wherein the width dimension of the holdup chamber is greater than the width dimension of at least one of the entry conduit or exit conduits.

3. The riser of claim 1, wherein the width dimension of the holdup chamber is greater than the width dimension of both of the entry conduit and exit conduits.

4. The riser of claim 1, wherein the holdup chamber includes an angled lower surface and an angled upper surface.

5. The riser of claim 4, wherein the angled lower surface and the angled upper surface are each characterized by an angle of between about 20 degrees to about 60 degrees.

6. The riser of claim 1, wherein the holdup chamber disrupts the flow of the catalyst along an interior surface thereof.
